(19) United States
(12) Patent Application Publication
(10) Pub. No.: US 2024/0333485 A1
(43) Pub. Date: Oct. 3, 2024

(54) QUANTUM KEY DISTRIBUTION PROTOCOL ADAPTER

(71) Applicant: Arqit Limited, London (GB)

(72) Inventors: David Webb, Sussex (GB); Prakash Khaitan, Wiltshire (GB)

(21) Appl. No.: 18/579,155

(22) PCT Filed: Jun. 27, 2022
(86) PCT No.: PCT/GB2022/051640

§ 371 Date: Jan. 12, 2024

(30) Foreign Application Priority Data
Jul. 22, 2021 (GB) 2110574.7

(51) Int. Cl. H04L 9/08; H04L 9/30

(52) U.S. Cl. CPC H04L 9/0852; H04L 9/30

(57) ABSTRACT

A quantum key distribution (QKD) protocol adapter and method providing a first interface presenting a QKD protocol to a network element and a second interface arranged to use a key management protocol to communicate with a hardware security module (HSM). The adapter being arranged to use group shared keys provided to the HSM by a QKD system, and the adapter being arranged to respond to key status requests and key requests from the network element in the QKD protocol by interacting with the HSM using the key management protocol, and being arranged to provide the requested key status information or keys to the network element in the QKD protocol.

The present application relates to a quantum key distribution protocol adapter.

### BACKGROUND

Cryptography is used to protect billions of transactions every day from, without limitation, for example Transport Layer Security (TLS) security for online shopping and banking to ultra-secure government communications. These transactions rely on reliable and secure means for at least two or more transacting parties to share a secret key, enabling encryption of data by one party and subsequent decryption by other parties.

It is expected that when commercially usable universal quantum computers (QC) become available, a variety of types of transactions, tasks and applications including, without limitation, conventional key distribution processes will be vulnerable. QCs can potentially crack many classical cryptography codes almost effortlessly. The conventional manual key distribution process is not quantum secure by its nature of operation, as it is exposed to both quantum electronic and/or physical compromise at several of the steps involved.

It has been proposed to use techniques such as quantum key distribution (QKD), including satellite based quantum key distribution (SQKD), to allow two distant parties to share a key in an information theoretic secure way that is guaranteed by the laws of physics.

There are several competing protocols being adopted as the preferred way to connect QKD hardware to network equipment within a datacentre. One example of such a protocol is the ETSI QKD protocol, and another is the Cisco SKIP protocol. However, these protocols were designed for use within a trusted physical boundary, so that there may be problems in using these protocols in a cloud environment. For example, ETSI QKD relies on authentication at the TLS layer to authenticate parties, rather than building in authentication to its API. This makes it problematic for use in a cloud environment because of the need for mutual trust to be established through the use of mutually recognised TLS certificates at both client and server.

Accordingly, in order to use the known connection protocols way to connect QKD hardware to network equipment it is necessary for the QKD hardware to be inside a trusted physical boundary, and for the QKD hardware to be connected directly to the corresponding QKD hardware at the other end(s) of the connection using optical fibre, so that fibre QKD can be carried out directly between the different QKD hardware over the optical fibre connection. This approach has a number of problems, the communication distance is limited to a distance allowing fibre QKD to be carried out, currently this distance is typically a practical maximum of around 100 km, and the QKD hardware must be within the trusted physical boundary, limiting the possible system architectures, and this approach is not compatible with SQKD.

The embodiments described below are not limited to implementations which solve any or all of the problems of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

In a first aspect, the present disclosure provides a quantum key distribution (QKD) protocol adapter comprising: a first interface presenting a QKD protocol to a network element; a second interface arranged to use a key management protocol to communicate with a hardware security module (HSM); the adapter being arranged to use group shared keys provided to the HSM by a QKD system; and the adapter being arranged to respond to key status requests and key requests from the network element in the QKD protocol by interacting with the HSM using the key management protocol, and being arranged to provide the requested key status information or keys to the network element in the QKD protocol.

In a second aspect, the present disclosure provides a system comprising an adapter according to the first aspect in combination with a network element, wherein the network element is arranged to cooperate with other network elements of the group of two or more network elements to mutually agree a group key for use to establish secure communications between the group of two or more network elements.

In a third aspect, the present disclosure provides quantum key distribution (QKD) protocol adapter comprising: a first interface presenting a QKD protocol to a network element; a second interface arranged to use a key management protocol to communicate with a secure key store; the adapter being arranged to use group shared keys provided to the secure key store by a cloud service; the adapter being arranged to perform agreement of keys with at least one another adapter through the cloud service; and the adapter being arranged to respond to key status requests and key requests from the network element in the QKD protocol by interacting with the secure key store using the key management protocol, and being arranged to provide the requested key status information or keys to the network element in the QKD protocol.

In a fourth aspect, the present disclosure provides a system comprising an adapter according to the third aspect in combination with a network element, wherein the network element is arranged to cooperate with other network elements of the group of two or more network elements to mutually agree a group key for use to establish secure communications between the group of two or more network elements.

In a fifth aspect, the present disclosure provides a method of operating a quantum key distribution (QKD) protocol adapter, the method comprising: using a first interface to present a QKD protocol to a network element; using a second interface to communicate with a hardware security module (HSM) using a key management protocol; wherein the adapter uses group shared keys provided to the HSM by a satellite QKD system; and wherein the adapter responds to key status requests and key requests from the network element in the QKD protocol by interacting with the HSM using the key management protocol, and to provide the requested key status information or keys to the network element in the QKD protocol.

In a sixth aspect, the present disclosure provides a method of operating a quantum key distribution (QKD) protocol adapter, the method comprising: using a first interface to present a QKD protocol to a network element; using a second interface arranged to communicate with a secure key store using a key management protocol; wherein the adapter uses group shared keys provided to the secure key store by a cloud service; wherein the adapter performs agreement of keys with at least one another adapter through the cloud service; and wherein the adapter responds to key status requests and key requests from the network element in the QKD protocol by interacting with the secure key store using the key management protocol, and providing the requested key status information or keys to the network element in the QKD protocol.

In a seventh aspect, the present disclosure provides a computer-readable medium comprising code or computer instructions stored thereon, which when executed by a processor, causes the processor to perform the method according to the fifth aspect or the sixth aspect.

The computer-readable medium may be a non-transient computer readable medium.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram illustrating a pair of datacentres arranged for encrypted communication according to a first embodiment;

FIG. 2 is a schematic diagram illustrating a protocol adapter according to the first embodiment;

FIG. 3 is a schematic diagram of a first workflow useable in the first embodiment;

FIG. 4 is a schematic diagram illustrating a pair of datacentres arranged for encrypted communication according to a second embodiment;

FIG. 5 is a schematic diagram of a second workflow useable in the second embodiment;

FIG. 6 is a schematic diagram of a third workflow useable in the second embodiment; and

FIG. 7 is a schematic diagram illustrating a pair of datacentres arranged for encrypted communication according to a third embodiment.

Common reference numerals are used throughout the figures to indicate similar features.

### DETAILED DESCRIPTION

Embodiments of the present invention are described below by way of example only. These examples represent the best mode of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

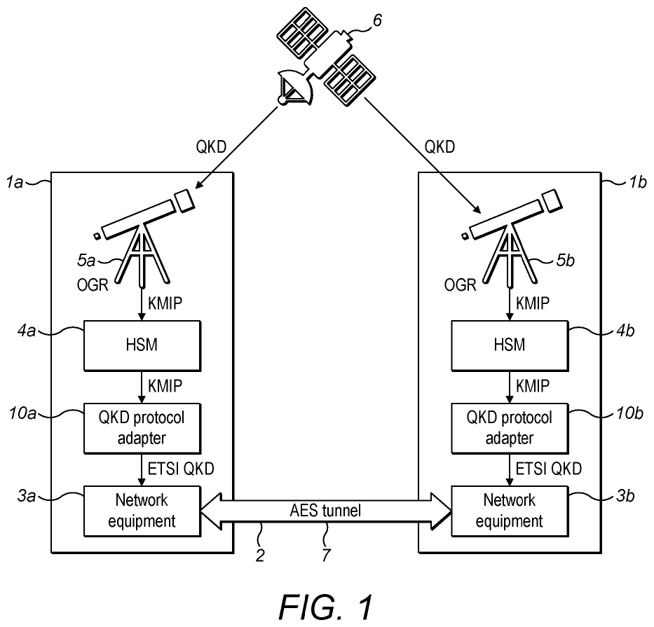

FIG. 1 shows a schematic overview of a first embodiment in which two separate entities, such as datacentres, are arranged for encrypted communication using quantum key distribution (QKD) encryption keys. In the illustrated first embodiment the data centres are provided with QKD encryption keys by a satellite quantum key distribution (SQKD) system. It will be understood that the SQKD system may have many additional elements which are not shown in FIG. 1.

As shown in FIG. 1, a first datacentre 1a and a second datacentre 1b are connected by a communications network 2. The communications network 2 may be any known communications network, such as a telecommunications network. The first datacentre 1a comprises a network module 3a, a hardware security module (HSM) 4a, an optical ground receiver (OGR) 5a, and a QKD proxy or QKD adapter 10a. Similarly, the second datacentre 1b comprises a network module 3b, an HSM 4b, an OGR 5b, and a QKD proxy or QKD adapter 10a. Each of the first and second datacentres 1a and 1b provides a trusted physical boundary containing the elements identified above. However, the first and second datacentres 1a and 1b are separate, and may be remote, and are not within a common trusted physical boundary.

The OGRs 5a and 5b of the first and second datacentres 1a and 1b are arranged to cooperate with a satellite 6 of an SQKD system to generate common shared QKD encryption keys at each of the first and second datacentres 1a and 1b. There are a number of methods and protocols which may be used to generate such shared QKD encryption keys, and any of these may be used. The illustration of the satellite 6 is by way of example only. It is not necessarily the case that the satellite 6 is in communication with both of the first and second datacentres 1a and 1b simultaneously, this is not required in all SQKD protocols.

At the first datacentre 1a, the OGR 5a provides the generated QKD encryption keys to the HSM 4a for secure storage. Similarly, at the second datacentre 1b, the OGR 5b provides the generated QKD encryption keys to the HSM 4b for secure storage. The OGRs 5a and 5b communicate with the respective HSMs 4a and 4b using a suitable cryptographic key management protocol, such as the Key Management Interoperability Protocol (KMIP), or Public-Key Cryptography Standards #11 (PKCS #11). In the illustrated embodiment of FIG. 1, KMIP is used.

It will be understood that it could be argued that QKD keys cease to be QKD keys when they are communicated over a classic channel using classic cryptography. However, it is common practice for keys originally provided by QKD to still be referred to as QKD keys even after they have been communicated over a classic channel using classic cryptography, and the term “QKD key” is used in this manner herein to refer to both QKD keys according to the strict definition and QKD derived or originating keys. That is, QKD keys is used herein to include keys which were originally produced and/or delivered by QKD, but which have subsequently been transported by secure classical, but not QKD, mechanisms.

It will be understood that, in general, the HSM 4a and 4b of each of the datacentres 1a and 1b do not contain only the QKD encryption keys shared with the other one of the datacentres 1a and 1b, but may also contain QKD encryption keys shared with other datacentres, and other encryption keys used for other purposes. Each HSM 4a and 4b will store QKD encryption keys, and optionally other encryption keys according to a predetermined schema.

The network module 3a of the first datacentre 1a is able to form a secure communications connection 7 to other corresponding network modules, such as the network module 3b of the second datacentre 1b, through the communications network 2. Similarly, the network module 3b of the second datacentre 1b is able to form a secure communications connection 7 to other corresponding network modules, such as the network module 3a of the first datacentre 1a, through the communications network 2. The network modules 3a and 3b may comprise suitable networking equipment, such as routers, firewalls, etc.

The network modules 3a and 3b support a QKD communications protocol, such as the ETSI QKD protocol or the Cisco Secure Key Integration Protocol (SKIP). In the illustrated embodiment of FIG. 1, the ETSI QKD protocol is used. The network modules 3a and 3b are each able to establish a secure communications tunnel, such as an Advanced Encryption Standard (AES) tunnel, a Media Access Control Security (MACSec) tunnel, or an Internet Protocol Security (IPSec) tunnel, with a corresponding network module through the communications network 2, using a key agreement protocol, such as Internet Key Exchange (IKE), provided that suitable common QKD encryption keys are available to the different network modules 3a and 3b. In the illustrated embodiment of FIG. 1, the network modules 3a and 3b are arranged to establish an AES tunnel as a secure communications connection 7 between the first and second datacentres 1a and 1b.

In examples where the ETSI QKD protocol is used, this may, for example, be ETSI GS QKD 014, Quantum Key Distribution (QKD); Protocol and data format of REST-based key delivery API as described at https://www.etsi.org/deliver/etsi_gs/QKD/001_099/014/01.01.01_60/gs_qkd01 4v010101p.pdf, or ETSI GS QKD 004, Quantum Key Distribution (QKD); Application Interface as described at https://www.etsi.org/deliver/etsi_gs/QKD/001_099/004/02.01.01_60/gs_qkd00 4v020101p.pdf.

The QKD adapter 10a of the first datacentre 1a connects the network module 3a to the HSM 4a. Similarly, the QKD adapter 10b of the second datacentre 1b connects the network module 3b to the HSM 4b. As shown in FIG. 1, each QKD adapter 10a or 10b presents an ESI QKD REST interface to the respective network module 3a or 3b, and uses comprises an interface which uses KMIP to communicate or link with the respective HSM 4a or 4b. In examples where the network module 3a or 3b uses a different QKD communications protocol, such as SKIP, the QKD adapter 10a or 10b uses that protocol. Similarly, in examples where the HSM 4a or 4b uses a different cryptographic key management protocol, such as PKCS #11, the QKD adapter 10a or 10b uses that protocol. Accordingly, each QKD adapter 10 acts as a proxy or adapter between the network module 3 and the HSM 4.

Although FIG. 1 shows only first and second datacentres 1a and 1b, there may be a group of any number of datacentres 1 arranged to establish a mutual tunnel for secure communication.

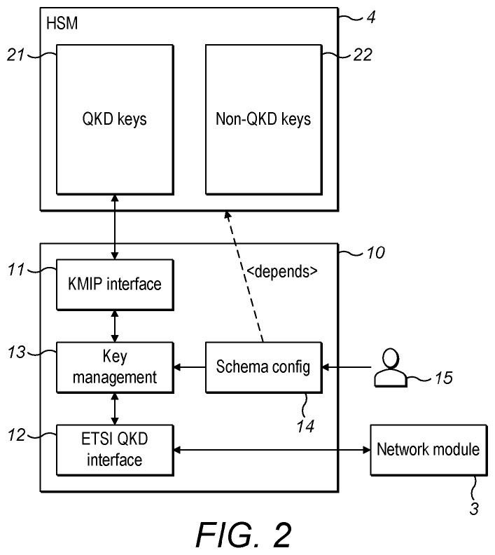

FIG. 2 shows a schematic diagram of a QKD adapter 10 according to the first embodiment. The illustrated embodiment of FIG. 2 corresponds to the illustrated embodiment of FIG. 1, where the network module 3 uses the ETSI QKD protocol and the HSM 4 uses the KMIP protocol. The QKD adapters 10a and 10b of FIG. 1 both correspond to the QKD adapter 10 of FIG. 2. The QKD adapter 10 may be a physical or virtual device.

The QKD adapter 10 comprises a KMIP interface 11 arranged for communication with an HSM 4 and an ETSI QKD interface 12 arranged for communication with a network module 3. The KMIP interface 11 may be regarded as consuming a key management protocol presented by the HSM 4. The QKD adapter 10 further comprises a key management module 13 and a schema configuration store 14. In examples where the ETSI GS QKD 014 QKD protocol is used, the ETSI QKD interface 12 of the QKD adapter 10 exposes the ETSI APIs to the network module 3 to which it is connected, providing capability for TLS certificates to be installed by an administrator. In the ETSI GS QKD 014 QKD protocol, TLS mutual authentication is used to authenticate the network module 3 to the ETSI QKD interface 12 of the QKD adapter 10, and to authenticate the QKD interface 12 of the QKD adapter 10 to the network module 3, in order to prevent any possible man-in-the-middle type attack. Accordingly, an administrator would need to install the necessary trusted TLS certificates onto the QKD adapter 10 and the network module 3, so that they can handle any required TLS mutual authentication. In examples where a different QKD protocol is used, such as the ETSI GS QKD 004 QKD protocol, alternative authentication methods may be used by the QKD adapter 10. The ETSI GS QKD 004 QKD protocol does not specify the use of any particular authentication method.

The HSM 4 contains stored QKD encryption keys 21 shared with the HSMs 4 of other datacentres 1, and may also contain other stored encryption keys 22. As is discussed above, the HSM 4 stores these different encryption keys according to a predetermined schema.

The schema configuration store 14 contains a stored schema definition for the HSM 4 which the QKD adapter 10 is to communicate with, that is, the HSM 4 of the datacentre 1 the QKD adapter 10 is comprised in. The stored schema definition comprises a definition of which QKD encryption keys can be used by the QKD adapter 10 and which cannot, this can, for example, be defined by rules which reference key metadata associated with the QKD encryption keys. The stored schema definition also comprises a definition of how the QKD adapter 10 can understand which QKD encryption keys are shared with which other OGRs 3 and/or HSMs 4, this can, for example, be defined by rules which reference key metadata associated with the QKD encryption keys. In examples where the HSM 4 also stored other encryption keys, which are not QKD encryption keys, the stored schema definition further comprises a definition of any segregation of keys within the HSM 4.

The QKD adapter 10 will need to be configured to understand the HSM schema used by the HSM 4 before it can begin operating. This configuration may be carried out by a user 15, or some other entity, providing the schema definition to the QKG adapter 10 for storage in the schema configuration store 14.

Each QKD adapter 10 may be a physical device, as shown in FIG. 1. In alternative examples, each QKD adapter 10 may be a virtual device, or software, such as a container running on board the network module 3, or some other part of the datacentre 1.

A detailed description of the method carried out by QKD adapters 10 are set out below for QKD adapters 10 using the ETSI GS QKD 014 QKD protocol. It will be understood that this description is provided by way of example only. If an alternative QKD protocol were used instead, such as the ETSI GS QKD 004 QKD protocol, the method will need to be adapted as necessary to match the requirements of the specific QKD protocol used and the specific APIs of that QKD protocol, which will deliver corresponding functionality to the ETSI GS QKD 004 API, but in a slightly different fashion. The skilled person will understand how to make such adaptations, which will depend upon the details of the QKD protocol used in any specific implementation.

The ETSI GS QKD 014 QKD protocol and API comprises three simple REST APIs, as set out in Table 1 below:

TABLE 1

| API Name | Functionality |
|---|---|
| Get status | Returns status of the capability between this Key Management |
| | Entity (KME) and the specified KME (i.e. how many keys are |
| | shared between this KME and the specified KME). |
| Get keys | Returns specified number of keys at the specified bit-length, |
| | where the keys to be used are chosen by the KME, given a set |
| | of other KMEs with which the keys are to be shared |
| Get keys | Returns the keys specified by ID. |
| with IDs | |

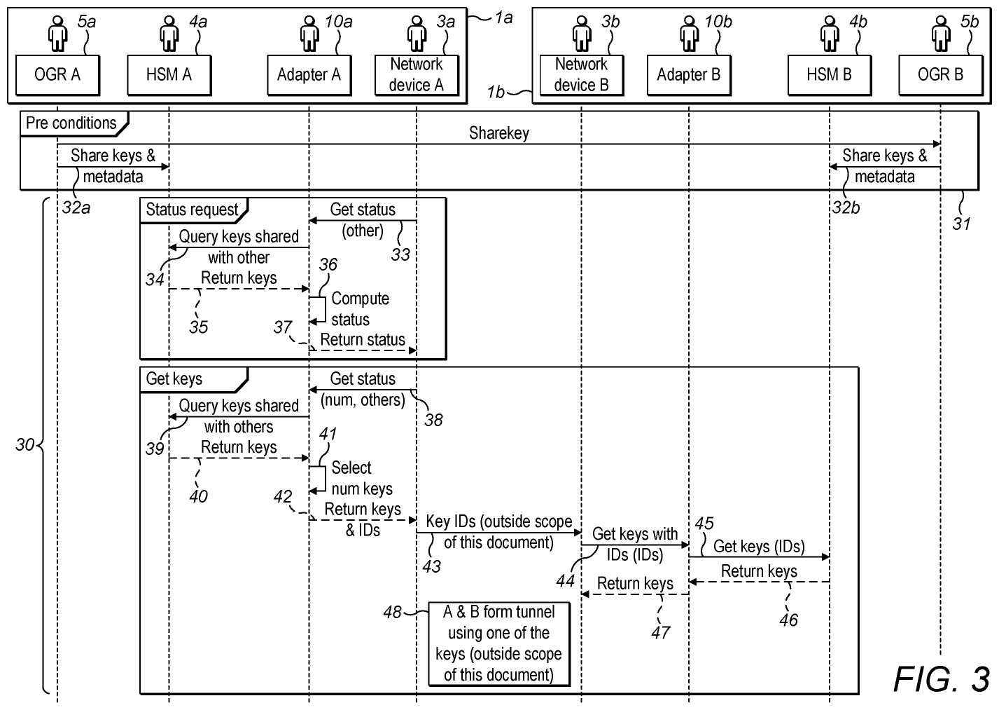

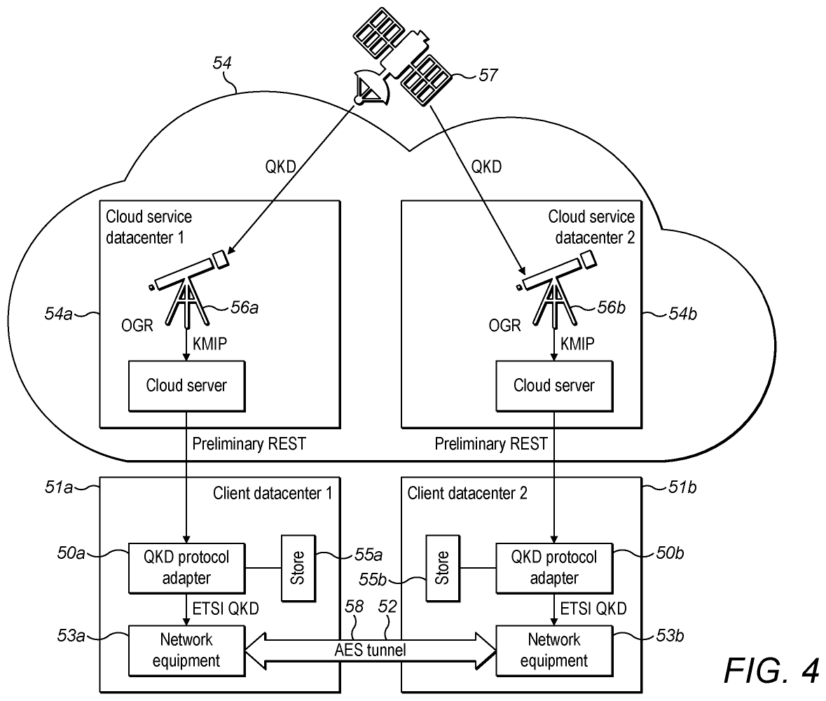

FIG. 3 shows a schematic diagram of an example of a workflow 30 carried out using QKD adapters 10a and 10b to enable common shared QKD encryption keys to be provided to the network modules 3a and 3b of the first and second datacentres 1a and 1b according to a first embodiment.

As shown in FIG. 3, the first datacentre 1a comprises the network module 3a, the QKD adapter 10a, the HSM 4a and the OGR 5a, and the second datacentre 1b comprises the network module 3b, the QKD adapter 10b, the HSM 4b and the OGR 5b. In the illustrated example of FIG. 3, the workflow starts when the network module 3a of the first datacentre 1a needs to establish secure communications with the network module 3b of the second datacentre 1b. It will be understood that this could be reversed.

In the first embodiment, it is necessary that the respective HSMs 4a and 4b of the first and second datacentres 1a and 1b contain a pool of common shared QKD encryption key(s) in order to enable secure communications to be established between them. Accordingly, it is a necessary pre-condition of the workflow 30 that an SQKD session 31 has been carried out by the OGR 5a and the OGR 5b, and the resulting common shared QKD encryption keys and respective key identifiers have been stored 32a in the HSM 4a by the OGR 5a, and have been stored 32b in the HSM 4b by the OGR 5b. This SQKD session 31 and the storing 32a and 32b of the resulting common shared QKD encryption keys may be carried out in any conventional manner, and does not involve the QKD adapters 10a and 10b. The key identifiers may be stored as key metadata associated with the QKD encryption keys. In this example the common shared QKD encryption keys are provided by a previous SQKD session 31. It will be understood that in other examples a different QKD mechanism may be used instead of an SQKD session to provide the common shared QKD encryption keys.

The workflow 30 starts when the network module 3a of the first datacentre 1a needs to establish secure communications with the network module 3b of the second datacentre 1b. The network module 3a sends 33 an ETSI QKD “Get Status” query to the QKD adapter 10a, the “Get Keys” query identifying the QKD adapter 10b of the second datacentre 1b as the key management entity (KME) of interest.

The QKD adapter 10a receives the “Get Status” query through the ETSI QKD interface 12. The key management module 13 of the QKD adapter 10a then retrieves the stored schema definition for the HSM 4a from the schema configuration store 14, and uses the stored schema definition to generate a status query in KMIP which will use the key metadata associated with the QKD encryption keys to identify QKD encryption keys stored in the HSM 4a which are shared with the identified QKD adapter 10b. The QKD adapter 10a then sends 34 the status query using KMIP through the KMIP interface 11 to the HSM 4a.

In response to the status query, the HSM 4a returns 35 information regarding the shared QKD encryption keys stored in the HSM 4a which are shared with the identified QKD adapter 10b. The QKD adapter 10a receives the returned shared QKD encryption key information through the KMIP interface 11. The key management module 13 of the QKD adapter 10a then uses the returned QKD encryption key information to compute 36 the number of identified shared QKD encryption keys. The QKD adapter 10a then sends 37 a status message including the number of shared QKD encryption keys using the ETSI QKD protocol to the network module 3a through the ETSI QKD interface 12. The status message may include various other information in addition to the number of shared QKD encryption keys, as desired in any specific implementation.

Subsequently, the network module 3a sends 38 an ETSI QKD “Get Keys” query to the QKD adapter 10a, the “Get Keys” query identifying the QKD adapter 10b of the second datacentre 1b as the KME of interest, and specifying the number of QKD encryption keys required, and optionally, the required bit length of the keys. It may not be necessary to specify the required bit length in some examples, such as systems where the network module key size is the same length as the size of keys in the HSM.

The QKD adapter 10a receives the “Get Keys” query through the ETSI QKD interface 12. The key management module 13 of the QKD adapter 10a then retrieves the stored schema definition for the HSM 4a from the schema configuration store 14, and uses the stored schema definition to generate a query in KMIP to identify QKD encryption keys stored in the HSM 4a which are shared with the identified QKD adapter 10b. The QKD adapter 10a then sends 39 the query using KMIP through the KMIP interface 11 to the HSM 4a.

In response to the query, the HSM 4a returns 40 the shared QKD encryption keys stored in the HSM 4a which are shared with the identified QKD adapter 10b, together with associated metadata. The QKD adapter 10a receives the returned shared QKD encryption keys through the KMIP interface 11.

The key management module 13 of the QKD adapter 10a then selects 41 a number of the returned QKD encryption keys corresponding to the number of QKD encryption keys identified as required in the “Get Keys” query 38. The QKD adapter 10a then returns 42 the selected QKD encryption keys and their respective key identifiers, which may be determined from the associated metadata, using the ETSI QKD protocol to the network module 3a through the ETSI QKD interface 12.

The network module 3a then transmits 43 the key identifiers of the selected QKD encryption keys to the network module 3b of the second datacentre 1b. How this transmitting of the key identifiers is carries out is outside the scope of the ETSI QKD protocol; specification. This transmission of key identifiers may be carried out in an appropriate manner for the QKD protocol being used based on users security needs, for example through a classical (not QKD secured) communications channel. The skilled person is aware of a number of established ways of carrying out such key identifier transmission, which does not need to be described in detail herein.

At the second datacentre 1b, the network module 3b receives the key identifiers of the selected QKD encryption keys from the network module 3a of the first datacentre 1a, and sends 44 an ETSI QKD “Get Keys with IDs” query to the QKD adapter 10b, the “Get Keys with IDs” query including the key identifiers of the selected QKD encryption keys.

The QKD adapter 10b receives the “Get Keys with IDs” query through the ETSI QKD interface 12. The key management module 13 of the QKD adapter 10b then retrieves the stored schema definition for the HSM 4b from the schema configuration store 14, and uses the stored schema definition to generate a get keys request in KMIP including the key identifiers of the selected QKD encryption keys. The QKD adapter 10b then sends 45 the get keys request using KMIP through the KMIP interface 11 to the HSM 4b.

In response to the get keys request, the HSM 4b returns 46 the QKD encryption keys stored in the HSM 4b corresponding to the provided key identifiers. The QKD adapter 10b receives the returned shared QKD encryption keys through the KMIP interface 11. The key management module 13 of the QKD adapter 10b then sends 47 the returned QKD encryption keys using the ETSI QKD protocol to the network module 3b through the ETSI QKD interface 12. These common shared QKD encryption keys may be regarded as group keys available to the group of the two first and second data centres 1a and 1b, which are used by their respective QKD adapters 10a and 10b.

The network modules 3a and 3b of the first and second data centres 1a and 1b then have the same common shared QKD encryption keys available, and the network modules 3a and 3b cooperate to use one of these common shared QKD encryption keys to establish 48 a secure tunnel through the communications system 2. This establishing of a secure tunnel may be carried out in an appropriate manner for the encryption protocol being used based on users security needs. The skilled person is aware of a number of ways of establishing such a secure tunnel, which does not need to be described in detail herein.

As is explained above, the QKD encryption key used is chosen by the initiator of the connection from a pool of keys and the ID of the selected QKD encryption key is communicated to the responder of the connection over a classical channel, enabling the responder to use the same key as the initiator to establish the secure tunnel.

In the illustrated example of FIG. 3, the workflow starts when the network module 3a of the first datacentre 1a needs to establish secure communications with the network module 3b of the second datacentre 1b. It will be understood that this could be reversed.

In the illustrated example of FIG. 3, secure communications are established between a group of two datacentres 1a and 1b. The approach of FIG. 3 can easily be extended to establish secure communications among a group comprising any desired number of datacentres 1. In some examples, to do this, all of the datacentres 1 in the group must have a pool of common shared QKD encryption key(s) delivered by QKD in order to enable secure communications to be established between them. These common shared QKD encryption key(s) may be referred to as group shared keys. Steps 33 to 42 can then be carried out with the change that all of the other members of the group must be specified in steps 33, 34, 38 and 39 and the common shared QKD encryption keys shared by all members of the group must be returned in steps 35 and 40. In step 43, the network module 3a of the first datacentre 1a must send the key identifiers to the network modules of all of the other members of the group, and steps 44 to 47 must be carried out separately by each of the other members of the group. All of the network modules of the members of the group can then establish mutual secure tunnels in step 48. In some examples, the datacentres 1 in a group of more than two datacentres 1 may be arranged into pairs, with each pair of datacentres 1 having a pool of common shared QKD encryption key(s) delivered by QKD to enable secure communications to be established between them, these common shared QKD encryption key(s) being group shared keys or bilocation keys for that pair of datacentres 1.

The different pairs of datacentres 1 can then use a group key protocol to use the shared keys of the different pairs of datacentres 1 to agree a group key for all of the datacentres 1 in the group. In some examples, the datacentres 1 in the group may be arranged as a ring, and each pair of neighbouring datacentres 1 in the ring agree a key between them which is used to “seed”, or otherwise generate, a group key used by all the datacentres 1 in the group.

The response of the QKD adapter 10 of the first embodiment, where the QKD adapter 10 obtains QKD keys from an HSM 4 and an OGR 5, to each of the APIs of the ETSI QKD protocol is set out in table 2 below:

TABLE 2

| API Name | QKD Adapter Response |
|---|---|
| Get status | Determine the number of available keys shared |
| | with the specified other KME. |
| | Return status information. |
| Get keys | Identify required number of keys shared with the |
| | one or more other KMEs by examining key metadata in |
| | the HSM. Return required number of keys and their IDs. |
| Get keys | Return the specified keys. |
| with IDs | |

In the illustrated example of FIGS. 1 to 3, the networking modules use ETSI QKD. It will be understood that the networking modules may use other QKD or key agreement protocols, for example SKIP (Cisco). It will be understood that other types of networking equipment or other security devices (physical or virtual) may be used.

The present disclosure enables networking equipment to establish a secure MACSec or IPSec tunnel between themselves by each retrieving the same key from their respective local HSMs. Further, the present disclosure enables existing and legacy devices, such as HSMs, which do not support the ETSI QKD or SKIP protocols, or similar QKD protocols, to be used to securely provide QKD keys to networking equipment that uses these protocols.

FIG. 4 shows a schematic overview of a second embodiment in which two separate client datacentres are arranged for encrypted communication using quantum key distribution (QKD) encryption keys. In the illustrated second embodiment the client data centres are provided with QKD encryption keys by a symmetric key distribution cloud service provided with QKD encryption keys by an SQKD system. An example of such a symmetric key distribution cloud service is the QuantumCloud™. It will be understood that the cloud service and SQKD system may have many additional elements which are not shown in FIG. 4.

As shown in FIG. 4, a first client datacentre 51a and a second client datacentre 51b are connected by a communications network 52. The communications network 52 may be any known communications network, such as a telecommunications network. The first datacentre 51a comprises a network module 53a, a secure key store 55a, and a QKD proxy or QKD adapter 50a. Similarly, the second datacentre 51b comprises a network module 53b, a secure key store 55b, and a QKD proxy or QKD adapter 50a. Each of the first and second datacentres 51a and 51b provides a trusted physical boundary containing the elements identified above. However, the first and second client datacentres 51a and 51b are separate, and may be remote, and are not within a common trusted physical boundary.

The first and second datacentres 51a and 51b are provided with QKD encryption keys by a cloud service 54. The cloud service 54 may, for example, be QuantumCloud. The cloud service 54 comprises a first OGR 56a associated with, and providing QKD encryption keys to, a first cloud service part 54a associated with the first datacentre 51a, and a second OGR 56b associated with, and providing QKD encryption keys to, a second cloud service part 54b associated with the second datacentre 51b. The first and second cloud service parts 54a and 54b of the cloud service 54 use the first and second OGRs 56a and 56b respectively, in cooperation with a satellite 57 of an SQKD system, to generate common shared QKD encryption keys, and provides these to the first and second datacentres 51a and 51b. Further, the cloud service 54 supports and enables symmetric key agreement between parties with the cloud service 54 acting as a broker, and the first and second cloud service parts 54a and 54b provide these services to the QKD adapters 50a and 50b of the first and second datacenters 51a and 51b respectively. There are a number of methods and protocols which may be used to generate and agree shared QKD encryption keys, and any of these may be used. The illustration of the satellite 57 is by way of example only. It is not necessarily the case that the satellite 57 is in communication with both of the first and OGRs 56a and 56b simultaneously, this is not required in all SQKD protocols. These common shared QKD encryption keys may be regarded as group keys available to the group of the two first and second data centres 51a and 51b, which are used by their respective QKD adapters 50a and 50b.

The network modules 53a and 53b of the first and second datacentres 51a and 51b are able to form a secure communications connection 58 to other corresponding network modules, such as one another. The network modules 53a and 53b are the same as the network modules 3a and 3b of the first embodiment.

The QKD adapter 50a of the first datacentre 51a connects the network module 53a to the first secure key store 55a and the first cloud service part 54a. Similarly, the QKD adapter 50b of the second datacentre 51b connects the network module 53b to the second secure key store 55b and the second cloud service part 54b. As shown in FIG. 4, each QKD adapter 50 presents an ESI QKD REST interface to the respective network module 53, uses an appropriate protocol to communicate with and link to the respective secure key store 55, and uses an appropriate cloud service protocol to communicate with the cloud service 54. The cloud service 54 will define what protocol is to be used for communication with the cloud service 54, and this is referred to as the cloud service protocol herein. In some examples the cloud service protocol may be a proprietary protocol. In other examples the cloud service protocol may be a generally used protocol, such as KMIP.

In examples where the network module 53a or 53b uses a different QKD communications protocol, such as SKIP, the QKD adapter 50a or 50b uses that protocol. Accordingly, each QKD adapter 50 acts as a proxy or adapter between the network module 53 and the secure key store 55 and cloud service 54.

In the second embodiment, each QKD adapter 50 must securely manage the QKD encryption keys stored in the respective secure key store 55. In some examples, the secure key store 55 may be a local HSM associated with, or incorporated in, the datacentre 51. In such examples, the QKD adapter 50 may comprise schema configuration information similarly to the QKD adapter 10 of the first embodiment. In other examples, the secure key store 55 may not be an HSM, and the QKD encryption keys stored in the secure key store 55 may be secured by using other technology. In some examples, the secure key store 55 may be implemented by a secure enclave, such as using Intel SGX, or a secure in-memory cache. In such examples, the QKD adapter 50 will have the necessary information to use the securing technology, such as Intel SGX, on the secure key store 55 in place of the schema configuration information of the QKD adapter 10 of the first embodiment. Each secure key store 55 stores bilocation keys from the session keys protocol, such that multiple confidential QKD keys can be derived from the same bilocation key, and stores the aforementioned derived confidential QKD keys that are agreed between the QKD adapters 50 and which are not known to the symmetric key distribution cloud service.

In the illustrated example of FIG. 4, the QKD encryption keys are generated by an SQKD system using the satellite 57. In alternative examples the SQKD system using the satellite 57 used to generate QKD encryption keys could be replaced by a terrestrial QKD system in which the first and second cloud service parts 54a and 54b are connected by optical fibre using suitable QKD modules instead of being connected to the satellite 57 by OGRs 56a and 56b.

Each QKD adapter 50 may be a physical device, as shown in FIG. 4. In alternative examples, each QKD adapter 50 may be a virtual device, or software, such as a container running on board the network module 53, or some other part of the datacentre 51.

Although FIG. 4 shows only first and second datacentres 51a and 51b, there may be a group of any number of datacentres 51 arranged to establish a mutual tunnel for secure communication.

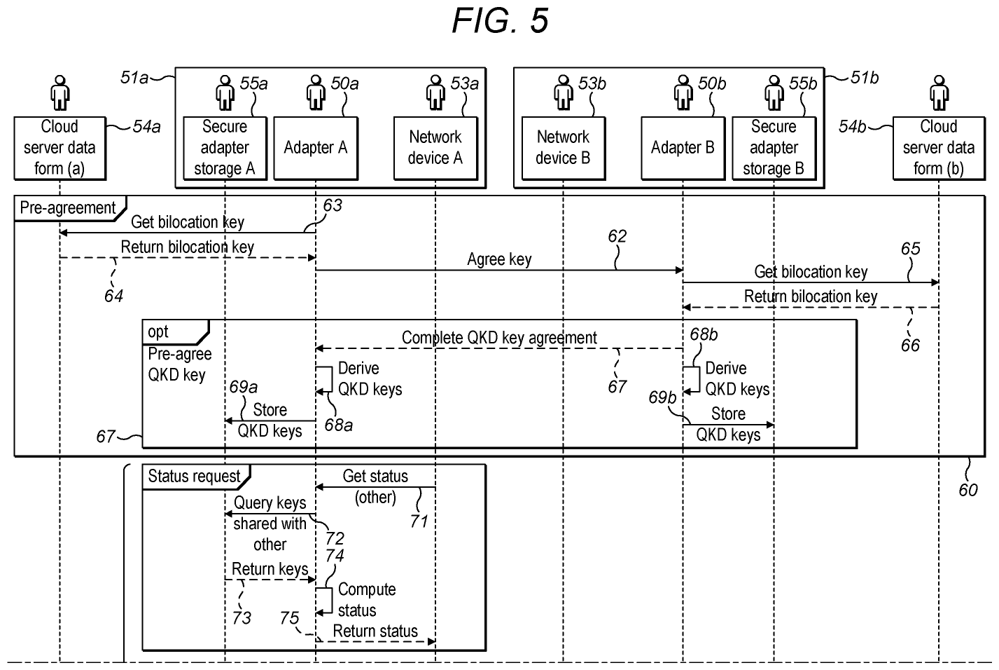

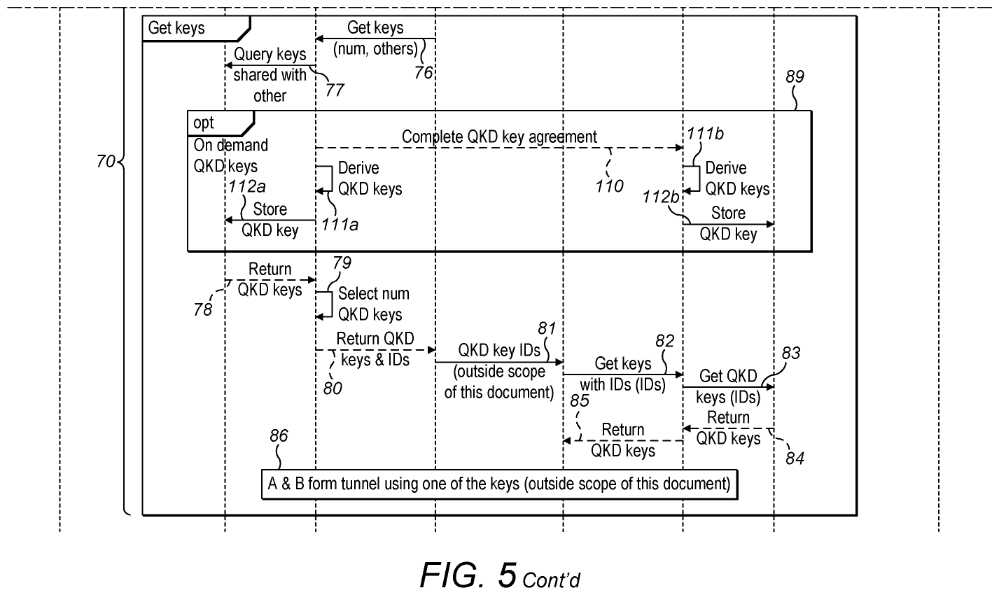

FIG. 5 shows a schematic diagram of an example of a workflow 70 carried out using QKD adapters 50a and 50b to enable common shared QKD encryption keys to be provided to the network modules 53a and 53b of the first and second datacentres 51a and 51b according to an example of the second embodiment where the QKD adapters 50a and 50b are arranged to pre-agree QKD encryption keys with one another in advance.

As shown in FIG. 5, the first datacentre 51a comprises the network module 53a, the QKD adapter 50a, and the secure key store 55a, and the second datacentre 51b comprises the network module 53b, the QKD adapter 50b, and the secure key store 55b. In the illustrated example of FIG. 5, the workflow 70 starts when the network module 53a of the first datacentre 51a needs to establish secure communications with the network module 53b of the second datacentre 51b. It will be understood that this could be reversed.

As is explained above, in the illustrated example of FIG. 5 the respective QKD adapters 50a and 50b of the first and second datacentres 51a and 51b pre-agree a pool of common shared QKD encryption key(s) in advance in order to enable secure communications to be established between them. Accordingly, it is a necessary pre-condition of the workflow 70 that a key agreement process 60 has been carried out.

In the illustrated example of FIG. 5, the key agreement process 60 starts when the QKD adapter 50a sends 63 a get bilocation key request to the first cloud service part 54a requesting a bilocation key which will be bilocated in both the first datacentre 51a and the second datacentre 51b. The first cloud service 54a responds to this request by returning 64 a bilocation key, together with its key identifier. Then, the QKD adapter 50a of the first datacentre 51a sends 62 an agree key request to the QKD adapter 50b of the second datacentre 51b.

Then, in response to the agree key request sent at 62, the QKD adapter 50b sends 65 a get bilocation key request to the second cloud service part 54b requesting the same bilocation key which is bilocated between the first datacentre 51a and the second datacentre 51b. The second cloud service 54b responds to this request by returning 66 the same bilocation key together with its key identifier. The underlying cloud service 54 ensures that the first cloud service 54a and the second cloud service part 54b return the same bilocation keys to the first and second QKD adaptors 50a and 50b. It will be understood that the key protocols used by the cloud service 54 will depend upon the implementation and organizational details of the cloud service, and are not described in detail herein. The key protocols used by the cloud service 54 may be arbitrarily complex, as required in any specific implementation.

Optionally, in a workflow 87, the QKD adapter 50b then sends 67 a complete key agreement message to the QKD adapter 50a, which enables the first QKD adapter 50a and the second QKD adapter 50b to respectively calculate 68a and 68b one or more confidential QKD keys and their respective key identifiers from the shared bilocation key and which one or more confidential QKD keys are not known to the first or second cloud service parts 54a or 54b. Then, the QKD adapter 50b stores 69b the agreed common QKD encryption keys, together with their key identifiers, into the secure key store 55b, while the QKD adapter 50a stores 69a the agreed common QKD encryption keys, together with their key identifiers, into the secure key store 55a. The key identifiers may be stored as key metadata associated with the QKD encryption keys.

Accordingly, if the optional workflow 87 is used, the key agreement process 60 provides in advance of the workflow 70 a pre-agreed pool of common shared confidential QKD encryption key(s) stored together with their key identifiers in the secure key stores 55a and 55b.

In an alternative arrangement, where the workflow 87 is not used, the common shared bilocation keys could be stored in respective HSMs of the first and second datacentres 51a and 51b, and the confidential QKD keys negotiated on-demand using at least one of these common shared bilocation keys in response to a request from the initiating datacentre. This alternative arrangement is described below.

The workflow 70 starts when the network module 53a of the first datacentre 51a needs to establish secure communications with the network module 53b of the second datacentre 51b. The network module 53a sends 71 an ETSI QKD “Get Status” query to the QKD adapter 50a, the “Get Keys” query identifying the QKD adapter 50b of the second datacentre 51b as the key management entity (KME) of interest.

The QKD adapter 50a receives the “Get Status” query through the ETSI QKD interface 12. The key management module 13 of the QKD adapter 50a then retrieves the necessary information regarding the secure key store 55a from the store 14, and uses the retrieved information to generate a status query to identify QKD encryption keys stored in the secure key store 55a which are shared with the identified QKD adapter 50b. The QKD adapter 50a then sends 72 the status query to the secure key store 55a. In examples where the secure key store 55a is an HSM, the retrieved necessary information may be a stored schema definition for the HSM from the schema configuration store 14, and the status query may be in KMIP, similarly to the first embodiment.

In response to the status query, the secure key store 55a returns 73 the shared QKD encryption key IDs stored in the secure key store 55a which are shared with the identified QKD adapter 50b. The QKD adapter 50a receives the returned shared QKD encryption key IDs. The key management module 13 of the QKD adapter 50a then uses the returned QKD encryption key IDs to compute 74 the number of identified shared QKD encryption keys. The QKD adapter 50a then sends 75 a status message including the number of shared QKD encryption keys using the ETSI QKD protocol to the network module 53a through the ETSI QKD interface 12.

Subsequently, the network module 53a sends 76 an ETSI QKD “Get Keys” query to the QKD adapter 50a, the “Get Keys” query identifying the QKD adapter 50b of the second datacentre 51b as the KME of interest, and specifying the number of QKD encryption keys required, and optionally, the required bit length of the keys. It may not be necessary to specify the required bit length in some examples, such as systems where all QKD encryption keys have the same bit length.

The QKD adapter 50a receives the “Get Keys” query through the ETSI QKD interface 12. The key management module 13 of the QKD adapter 50a then retrieves the necessary information regarding the secure key store 55a from the store 14, and uses the retrieved information to generate a status query to identify QKD encryption keys stored in the secure key store 55a which are shared with the identified QKD adapter 50b. The QKD adapter 50a then sends 77 the status query to the secure key store 55a. In examples where the secure key store 55a is an HSM, the retrieved necessary information may be a stored schema definition for the HSM from the schema configuration store 14, and the status query may be in KMIP, similarly to the first embodiment.

In an alternative arrangement where the optional workflow 87 is not used, an alternative optional workflow 88 is used instead. It should be understood that one of the optional workflows 87 and 88 must be used.

In the alternative arrangement where the optional workflow 88 is used, in response to the status query, the QKD adapter 50a sends 110 a complete key agreement message to the QKD adapter 50b. The first QKD adapter 50a and the second QKD adapter 50b then mutually respectively negotiate 111a and 111b one or more confidential QKD keys and their respective key identifiers from a mutually shared bilocation key stored in the respective HSMs of the first and second datacentres 51a and 51b, which one or more confidential QKD keys are not known to the first or second cloud service parts 54a or 54b. Then, the QKD adapter 50b stores 112b the agreed common QKD encryption keys, together with their key identifiers, into the secure key store 55b, while the QKD adapter 50a stores 112a the agreed common QKD encryption keys, together with their key identifiers, into the secure key store 55a. The key identifiers may be stored as key metadata associated with the QKD encryption keys.

In the arrangement where the optional workflow 88 is used, in response to the status query, the secure key store 55a returns 78 the shared QKD encryption keys stored in the secure key store 55a which are shared with the identified QKD adapter 10b, together with associated metadata. Alternatively, in the alternative arrangement where the optional workflow 88 is used, after the QKD adapter 50a stores 112a the agreed common QKD encryption keys, together with their key identifiers, into the secure key store 55a, the secure key store 55a returns 78 the shared QKD encryption keys stored in the secure key store 55a which are shared with the identified QKD adapter 10b, together with associated metadata.

For both options, the key management module 13 of the QKD adapter 50a then selects 79 a number of the returned QKD encryption keys corresponding to the number of QKD encryption keys identified as required in the “Get Keys” query 76. The QKD adapter 50a then sends 80 the selected QKD encryption keys and their respective key identifiers, which may be determined from the associated metadata, using the ETSI QKD protocol to the network module 53a through the ETSI QKD interface 12.

The network module 53a then transmits 81 the key identifiers of the selected QKD encryption keys to the network module 53b of the second datacentre 51b. How this transmitting of the key identifiers is carried out is outside the scope of the ETSI QKD protocol. This transmission of key identifiers may be carried out in an appropriate manner for the QKD protocol being used based on users security needs, for example through a classical (not QKD secured) communications channel. The skilled person is aware of a number of established ways of carrying out such key identifier transmission, which does not need to be described in detail herein.

At the second datacentre 51b, the network module 53b receives the key identifiers of the selected QKD encryption keys from the network module 53a of the first datacentre 51a, and sends 82 an ETSI QKD “Get Keys with IDs” query to the QKD adapter 50b, the “Get Keys with IDs” query including the key identifiers of the selected QKD encryption keys.

The QKD adapter 50b receives the “Get Keys with IDs” query through the ETSI QKD interface 12. The key management module 13 of the QKD adapter 50b then retrieves the necessary information regarding the secure key store 55b from the store 14, and uses the retrieved information to generate a get keys request including the key identifiers of the selected QKD encryption keys. The QKD adapter 50b then sends 83 the get keys request to the secure key store 55b. In examples where the secure key store 55b is an HSM, the retrieved necessary information may be a stored schema definition for the HSM from the schema configuration store 14, and the get keys request may be in KMIP, similarly to the first embodiment.

In response to the get keys request, the secure key store 55b returns 84 the QKD encryption keys stored in the secure key store 55b corresponding to the provided key identifiers. The QKD adapter 50b receives the returned shared QKD encryption key, and the key management module 13 of the QKD adapter 50b then sends 85 the returned QKD encryption keys using the ETSI QKD protocol to the network module 53b through the ETSI QKD interface 12.

The network modules 53a and 53b of the first and second data centres 51a and 51b then have the same common shared QKD encryption keys available, and the network modules 53a and 53b cooperate to use one of these common shared QKD encryption keys to establish 86 a secure tunnel through the communications system 52. This establishing of a secure tunnel may be carried out in an appropriate manner for the encryption protocol being used based on users security needs. The skilled person is aware of a number of ways of establishing such a secure tunnel, which does not need to be described in detail herein.

As is explained above, the QKD encryption key used is chosen by the initiator of the connection from a pool of keys and the ID of the selected QKD encryption key is communicated to the responder of the connection over a classical channel, enabling the responder to use the same key as the initiator to establish the secure tunnel.

In the illustrated example of FIG. 5, secure communications are established between a group of two datacentres 51a and 51b. The approach of FIG. 5 can easily be extended to establish secure communications among a group comprising any desired number of datacentres 51. In some examples, to do this, all of the datacentres 51 in the group must have a pool of common shared QKD encryption key(s) available to them through the cloud service 54. These common shared QKD encryption key(s) may be referred to as group shared keys. The key agreement process 60, and one of the optional workflows 87 and 88, can then be carried out between all of the members of the group in order establish a pre-agreed pool of common shared QKD encryption key(s) stored together with their key identifiers in the secure key stores of all members of the group to enable secure communications to be established between them. Steps 71 to 80 can then be carried out with the change that all of the other members of the group must be specified in steps 71, 72, 76 and 77 and the common shared QKD encryption keys shared by all members of the group must be returned in steps 73 and 78. In step 81, the network module 53a of the first datacentre 51a must send the key identifiers to the network modules of all of the other members of the group, and steps 82 to 85 must be carried out separately by each of the other members of the group. All of the network modules of the members of the group can then establish mutual secure tunnels in step 86. In some examples, the datacentres 51 in a group of more than two datacentres 51 may be arranged into pairs, with each pair of datacentres 51 having a pool of common shared QKD encryption key(s) delivered by QKD to enable secure communications to be established between them, these common shared QKD encryption key(s) being group shared keys or bilocation keys for that pair of datacentres 51. The different pairs of datacentres 51 can then use a group key protocol to use the shared keys of the different pairs of datacentres 51 to agree a group key for all of the datacentres 51 in the group. In some examples, the datacentres 51 in the group may be arranged as a ring, and each pair of neighbouring datacentres 51 in the ring agree a key between them which is used to “seed”, or otherwise generate, a group key used by all the datacentres 51 in the group.

The response of the QKD adapter 50 of the second embodiment where the QKD adapter 50 obtains QKD keys from a secure key store 55, in an example where QKD encryption keys are pre-agreed, to each of the APIs of the ETSI QKD protocol is set out in table 3 below:

TABLE 3

| API Name | QKD Adapter Response |
|---|---|
| Get status | Determine the number of shared keys in the secure |
| | key store (local key buffer) with the specified other KME. |
| | Return status information. |
| Get keys | Identify required number of keys shared with the one or |
| | more other KMEs. |
| | Return required number of keys and their IDs. |
| Get keys | Return the specified keys. |
| with IDs | |

The present disclosure enables networking equipment to establish a secure MACSec or IPSec tunnel between themselves by each retrieving the same key from their respective local HSMs. Further, the present disclosure enables existing and legacy devices, such as HSMs, which do not support the ETSI QKD or SKIP protocols, or similar QKD protocols, to be used to securely provide QKD keys to networking equipment that uses these protocols.

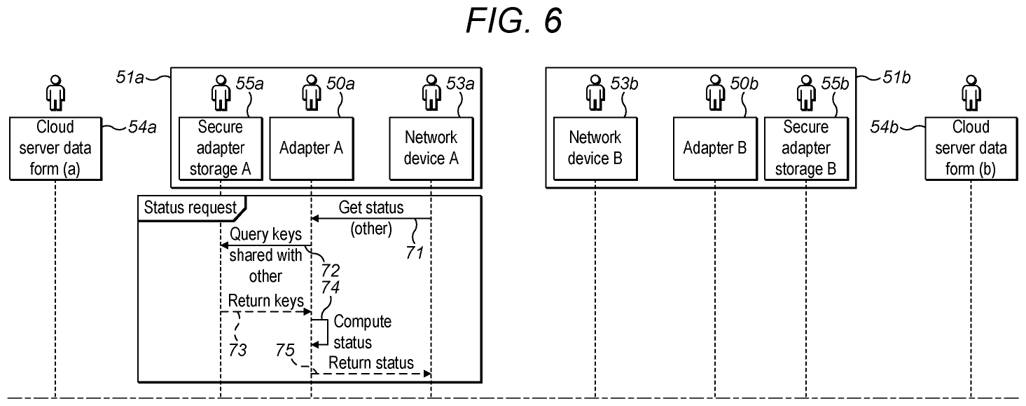

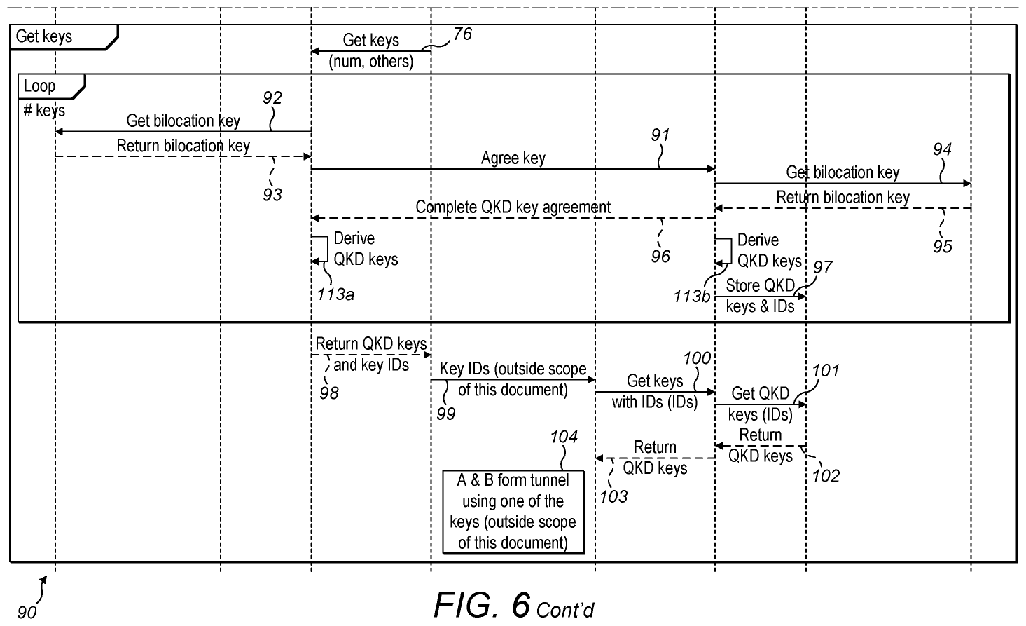

FIG. 6 shows a schematic diagram of an example of a workflow 90 carried out using QKD adapters 50a and 50b to enable common shared QKD encryption keys to be provided to the network modules 53a and 53b of the first and second datacentres 51a and 51b according to an example of the second embodiment where the QKD adapters 50a and 50b are arranged to agree keys dynamically on demand. In other words, without pre-agreement of QKD encryption keys with one another in advance.

As shown in FIG. 6, the first datacentre 51a comprises the network module 53a, the QKD adapter 50a, and the secure key store 55a, and the second datacentre 51b comprises the network module 53b, the QKD adapter 50b, and the secure key store 55b. In the illustrated example of FIG. 6, a workflow 90 starts when the network module 53a of the first datacentre 51a needs to establish secure communications with the network module 53b of the second datacentre 51b. It will be understood that this could be reversed.

The workflow 90 starts when the network module 53a of the first datacentre 51a needs to establish secure communications with the network module 53b of the second datacentre 51b. The workflow 90 comprises steps 71 to 76 which are the same as the corresponding numbered steps in the workflow 70 of FIG. 5.

As is discussed above regarding FIG. 5, the “Get Keys” query specifies the number of QKD encryption keys required. The workflow 90 is repeated a number of times corresponding to the number of QKD encryption keys specified in the “Get Keys” query. Each execution of the workflow 90 generates a single key agreed between the datacentres 51.

In the workflow 90, the QKD adapter 50a sends 92 a get bilocation key request to the first cloud service part 54a requesting a bilocation key, that is, a bilocated key that will be common to both the first datacentre 51a and the second datacentre 51b. The first cloud service 54a responds to this request by returning 93 a bilocation key, together with its key identifier. The QKD adapter 50a then sends 91 an agree key request to the QKD adapter 50b of the second datacentre 51b. In response to the agree key request sent at 91, the QKD adapter 50b sends 94 a get bilocation key request to the second cloud service part 54b requesting a bilocation key. The second cloud service part 54b responds to this request by returning 95 the requested same bilocation key, together with its key identifier. The underlying protocol used by the cloud service 54 ensures that the first cloud service 54a and the second cloud service part 54b return the same common bilocation key to the first and second QKD adaptors 50a and 50b.

The QKD adapter 50b then sends 96 a complete key agreement message to the QKD adapter 50a, which message enables the QKD adapters 50a and 50b to derive, 113a and 113b respectively, one or more confidential QKD encryption keys from the shared bilocation key which are not known to the cloud service 54. The QKD adapter 50b stores 97 the agreed shared QKD encryption keys, together with their key identifiers, into the secure key store 55b. The key identifiers may be stored as key metadata associated with the QKD encryption key. It should be understood that it is not necessary to store the agreed shared QKD encryption keys into the secure key store 55a, because the agreed shared QKD encryption keys produced by the workflow 90 will be returned immediately from memory to the first QKD adapter 50a. However, in some examples, the agreed shared QKD encryption key may be stored into the secure key store 55a.

Following reception of the complete key agreement message, the secure key store 55a returns 98 the requested number of common QKD encryption keys available to both the first cloud service part 54a and the second cloud service part 54b, together with their key identifiers, using the ETSI QKD protocol to the network module 53a through the ETSI QKD interface 12.

The network module 53a then transmits 99 the key identifiers of the selected QKD encryption keys to the network module 53b of the second datacentre 51b. This transmission of key identifiers may be carried out in an appropriate manner for the QKD protocol being used based on users security needs, for example through a classical (not QKD secured) communications channel. The skilled person is aware of a number of established ways of carrying out such key identifier transmission, which does not need to be described in detail herein.

At the second datacentre 51b, the network module 53b receives the key identifiers of the selected QKD encryption keys from the network module 53a of the first datacentre 51a, and sends 100 an ETSI QKD “Get Keys with IDs” query to the QKD adapter 50b, the “Get Keys with IDs” query including the key identifiers of the selected QKD encryption keys.

The QKD adapter 50b receives the “Get Keys with IDs” query through the ETSI QKD interface 12. The key management module 13 of the QKD adapter 50b then retrieves the necessary information regarding the secure key store 55b from the store 14, and uses the retrieved information to generate a get keys request including the key identifiers of the selected QKD encryption keys. The QKD adapter 50b then sends 101 the get keys request to the secure key store 55b. In examples where the secure key store 55b is an HSM, the retrieved necessary information may be a stored schema definition for the HSM from the schema configuration store 14, and the get keys request may be in KMIP, similarly to the first embodiment. In examples where the secure store is an in-memory cache, the keys will be recovered from the memory cache.

In response to the get keys request, the secure key store 55b returns 102 the QKD encryption keys stored in the secure key store 55b corresponding to the provided key identifiers. These will be the QKD encryption keys previously stored in the secure key store 55b in item 97. The QKD adapter 50b receives the returned shared QKD encryption key, and the key management module 13 of the QKD adapter 50b then sends 103 the returned QKD encryption keys using the ETSI QKD protocol to the network module 53b through the ETSI QKD interface 12.

The network modules 53a and 53b of the first and second data centres 51a and 51b then have the same common shared QKD encryption keys available, and the network modules 53a and 53b cooperate to use one of these common shared QKD encryption keys to establish 104 a secure tunnel through the communications system 52. This establishing of a secure tunnel may be carried out in an appropriate manner for the encryption protocol being used based on users security needs. The skilled person is aware of a number of ways of establishing such a secure tunnel, which does not need to be described in detail herein.

In the illustrated example of FIG. 6, secure communications are established between a group of two datacentres 51a and 51b. The approach of FIG. 6 can easily be extended to establish secure communications among a group comprising any desired number of datacentres 51. In some examples, to do this, all of the datacentres 51 in the group must have a pool of common shared QKD encryption key(s) available to them through the cloud service 54. Steps 71 to 76 can then be carried out with the change that all of the other members of the group must be specified in steps 71, 72 and 76 and the common shared QKD encryption keys shared by all members of the group must be returned in step 73. In steps 91 to 97 the key agreement must be carried out between all members of the group. In step 99, the network module 53a of the first datacentre 51a must send the key identifiers to the network modules of all of the other members of the group, and steps 100 to 103 must be carried out separately by each of the other members of the group. All of the network modules of the members of the group can then establish mutual secure tunnels in step 104. In some examples, the datacentres 51 in a group of more than two datacentres 51 may be arranged into pairs, with each pair of datacentres 51 having a pool of common shared QKD encryption key(s) delivered by QKD to enable secure communications to be established between them, these common shared QKD encryption key(s) being group shared keys or bilocation keys for that pair of datacentres 51. The different pairs of datacentres 51 can then use a group key protocol to use the shared keys of the different pairs of datacentres 51 to agree a group key for all of the datacentres 51 in the group. In some examples, the datacentres 51 in the group may be arranged as a ring, and each pair of neighbouring datacentres 51 in the ring agree a key between them which is used to “seed”, or otherwise generate, a group key used by all the datacentres 51 in the group.

The response of the QKD adapter 50 of the second embodiment where the QKD adapter 50 obtains QKD keys from a secure key store 55, in an example where QKD encryption keys are dynamically agreed, to each of the APIs of the ETSI QKD protocol is set out in table 4 below:

TABLE 4

| API Name | QKD Adapter Response |
|---|---|
| Get status | Return a current and maximum number of keys defined by |
| | policy (i.e specifying what the maximum number of keys |
| | per get key API call is supported). |
| | Return status information. |
| Get keys | Dynamically agree the required number of keys with the |
| | specified KMEs using the cloud service. |
| | Return required number of keys and their IDs. |
| Get keys | Return the specified keys. |
| with IDs | |

The present disclosure enables networking equipment to establish a secure MACSec or IPSec tunnel between themselves by each retrieving the same key from their respective local HSMs. Further, the present disclosure enables existing and legacy devices, such as HSMs, which do not support the ETSI QKD or SKIP protocols, or similar QKD protocols, to be used to securely provide QKD keys to networking equipment that uses these protocols.

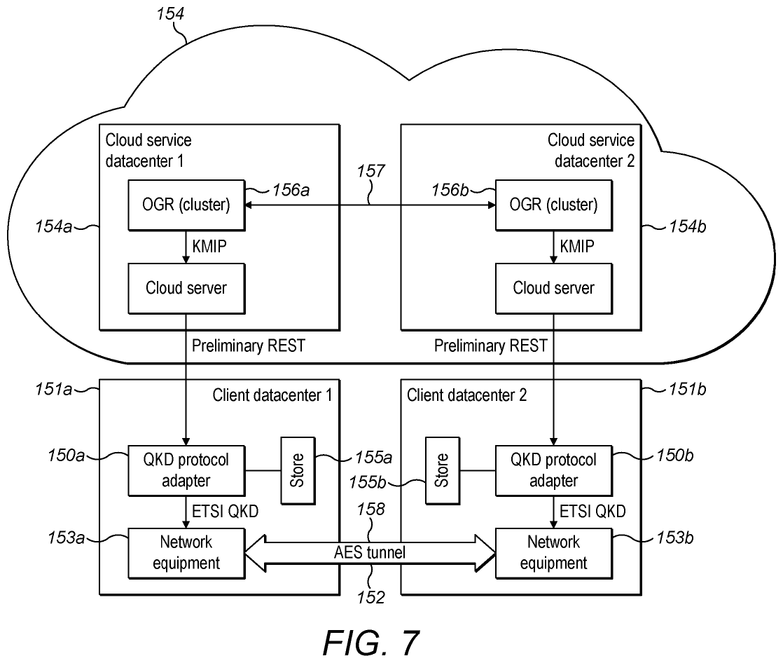

FIG. 7 shows a schematic overview of a third embodiment in which two separate datacentres are arranged for encrypted communication using quantum key distribution (QKD) encryption keys. In the illustrated third embodiment the data centres are provided with QKD encryption keys by a cloud service provided with QKD encryption keys by a terrestrial hardware security module (HSM) cluster system. An HSM cluster system is a group of HSMs that share keys over a secure tunnel, so that creating a key in one HSM of the cluster causes the same key to be created in all of the others. It will be understood that the cloud service and HSM cluster system may have many additional elements which are not shown in FIG. 7.

As shown in FIG. 7, a first datacentre 151a and a second datacentre 151b are connected by a communications network 152. The communications network 152 may be any known communications network, such as a telecommunications network. The first datacentre 151a comprises a network module 153a, a secure key store 155a, and a QKD proxy or QKD adapter 150a. Similarly, the second datacentre 151b comprises a network module 153b, a secure key store 155b, and a QKD proxy or QKD adapter 150a. Each of the first and second datacentres 151a and 151b provides a trusted physical boundary containing the elements identified above. However, the first and second datacentres 151a and 151b are separate, and may be remote, and are not within a common trusted physical boundary.

The first and second datacentres 151a and 151b are provided with QKD encryption keys by a cloud service 154. The cloud service 154 may, for example, be QuantumCloud. The cloud service 154 comprises a first HSM cluster 156a associated with, and providing QKD encryption keys to, a first cloud service part 154a associated with the first datacentre 151a, and a second HSM cluster 156b associated with, and providing QKD encryption keys to, a second cloud service part 154b associated with the second datacentre 151b. The first and second cloud service parts 154a and 154b of the cloud service 54 use the first and second HSM clusters 156a and 156b respectively, connected by optical fibres 157 of a terrestrial QKD system, to generate common shared QKD encryption keys, and provides these to the first and second datacentres 151a and 151b. Further, the cloud service 154 supports and enables symmetric key agreement between parties with the cloud service 154 acting as a broker, and the first and second cloud service parts 154a and 154b provide these services to the QKD adapters 150a and 150b of the first and second datacenters 151a and 151b respectively. There are a number of methods and protocols which may be used to generate and agree shared QKD encryption keys, and any of these may be used.

Although FIG. 7 shows only first and second datacentres 151a and 151b, there may be a group of any number of datacentres 151 arranged to establish a mutual tunnel for secure communication.

The first and second datacentres 151a and 151b of the third embodiment correspond to the first and second datacentres 51a and 51b of the second embodiment. Further, the first and second datacentres 151a and 151b of the third embodiment operate according to the workflows of FIGS. 6 and 7, depending whether the first and second datacentres 151a and 151b are arranged to carry out pre-agreement or dynamic agreement of QKD encryption keys, similarly to the second embodiment. It will be understood that the manner of operation of the cloud service 54 or 154, and in particular whether the cloud service 54 or 154 uses a satellite or terrestrial QKD approach does not affect the operation of the datacentres 51 and 151 or their component elements.

The illustrated embodiments provide key agreement and secure communication links between different datacentres. In other examples the disclosed approach can be used to provide key agreement and secure communication links between entities of any type, including entities of different types.

In the illustrated embodiments the ETSI QKD protocol is used. In other examples alternative QKD communication protocols may be used. In some examples the Cisco Secure Key Integration Protocol (SKIP). It is expected that in order to provide the required functionality any QKD communication protocol will require at least corresponding APIs to those of the ETSI QKD protocol discussed in detail above.

In the illustrated embodiments the key management interoperability protocol (KMIP) is used as a key management protocol. In other examples alternative key management protocols may be used. In some examples the PKCS #11 protocol may be used.

In the illustrated embodiments the EAP or IKE key agreement protocols are used. In other examples alternative key agreement protocols may be used.

The illustrated embodiments have the secure key store within the communicating entity, the datacentre in the illustrated embodiments. In other examples the secure key store may be placed in other locations.

In the embodiments described above the system is a quantum key distribution system. In other examples other cryptographic items could be distributed/delivered in addition to, or as an alternative to, encryption keys. Examples of such other cryptographic items include cryptographic tokens, cryptographic coins, or value transfers.

In the described embodiments of the invention parts of the system may be implemented as a form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Although illustrated as a single system, it is to be understood that a system may be a distributed system.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of preferred embodiments is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A quantum key distribution (QKD) protocol adapter comprising:
a first interface presenting a QKD protocol to a network element;
a second interface arranged to use a key management protocol to communicate with a hardware security module (HSM);
the adapter being arranged to use group shared keys provided to the HSM by a QKD system; and
the adapter being arranged to respond to key status requests and key requests from the network element in the QKD protocol by interacting with the HSM using the key management protocol, and being arranged to provide the requested key status information or keys to the network element in the QKD protocol.

2-40. (canceled)
